(19) United States
(12) Patent Application Publication
(10) Pub. No.: US 2002/0032037 A1
(43) Pub. Date: Mar. 14, 2002

(54) System for providing a virtual communication space corresponding to sensed information from the real world

(75) Inventor: Satoko Segawa, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 09/989,056

(22) Filed: Nov. 21, 2001

Related U.S. Application Data
(63) Continuation of application No. PCT/JP99/02956, filed on Jun. 2, 1999.

(51) Int. Cl. H04B 7/00

(52) U.S. Cl. 455/517

(57) ABSTRACT

A virtual communication space is constructed, in which people that actually see, hear or experience the same thing in the real world can exchange impressions or opinions in real-time.

A user carrying a user terminal 20 moves in the real world and enters a predetermined space of the real world that is controlled and supervised by a virtual communication space providing portion 30. The virtual communication space providing portion 30 sends communication channel identification information with a communication channel identification information notifying means 32, and a communication channel identification information sensing means 21 of the user terminal 20 senses the communication channel identification information. Login into that communication channel is performed with a channel login/logout means 22. By logging in, the virtual communication space provided by the virtual communication space providing portion 30 is shared, and applications such as an electronic bulletin board and chat can be used. The supervisor terminal collects/analyzes a log of the conversation.

### TECHNICAL FIELD

The present invention relates to a system for providing a virtual communication space that provides a virtual communication space between users present in a space that is shared in the real world (a building, a room, a well-defined locality), more specifically a space having a common purpose (such as a place where a certain product is sold, a place where a product is promoted, a research conference, a sports competition, or club facilities), or a space having a certain identity (such as a vacation spot or an event site).

### BACKGROUND ART

In recent years, as computers become smaller and lighter, so-called mobile computers, which can be carried around by the user and used for various purposes, are becoming more and more popular. In addition to applications such as word-processors and spread-sheets that can be used off-line at remote locations, there are also various network-dependent applications involving the sending and receiving of data by logging into a network, such as e-mail or internet browsing, for which communication functions are used.

Thus, the use of computers at remote locations making use of the capabilities of mobile computers is on the rise, but almost all network applications that can be used on conventional mobile computers make use of a network application that does not depend on the real world position or space of the remote location, which means that if a communication portal for a network such as the internet can be ensured, the internet can be used in the same environment anywhere in the real world. That is to say, in network applications that can be used with conventional mobile computers, the position and space in the real world is of absolutely no meaning, so that it become only an issue in terms of communication costs and communication speed.

An example of an application of conventional technology that depends on the position or space of the user in the real world is a navigation system. Such a system determines the position of the user terminal precisely with a position information detection system (GPS) and assists with selecting a route to the destination by combining the position of the user terminal with map information.

Another conventional application that depends on the position or space of the user in the real world is a system in which a visitor to a shop or a museum makes use of a portable device to obtain information regarding products or art works that is provided beforehand by the shop or the museum (referred to as “conventional position information utilizing system” in the following). In a simple arrangement of such a conventional position information utilizing system, a sender distributing voice information wirelessly is disposed near an art work, such as a painting, and the portable device of the user includes a radio receiver, so that the user can listen to the explanations with earphones.

As an application system based on this basic principle in which elements are replaced by substitution means, it is possible to conceive a system using an information providing server on a network, as shown in FIG. 12. An infrared transmitter and receiver 501 for example is arranged at a portion of or near an art work 500, such as a painting. A portable terminal 510 of the visitor is provided with an infrared transmitter and receiver 511. The infrared transmitter and receiver 501 arranged at the art work 500 receives an infrared signal sent out by the portable terminal 510 of the visitor. The infrared transmitter and receiver 501 notifies an ID number (in this example “#0001”) to a URL (universal resource locator) server 520 on a network in the museum. The URL server 520 supervises a URL table 522 correlating ID numbers of the infrared transmitter and receiver 501 and URL addresses of the sites presenting the information about the corresponding art work. A URL retrieval portion 521 retrieves the corresponding URL address from the URL table 522, and this URL information is sent back to the infrared transmitter and receiver 501. The infrared transmitter and receiver 501 sends the URL address by infrared ray to the portable terminal 510 of the visitor. The visitor obtains information from the information server 530 of the art work by accessing the URL address received with the communication function of the portable terminal 510, for example using a PHS 512. Another possible arrangement for this example is that the infrared transmitter and receiver 501 from the beginning holds the URL information of the server providing the information about the art work, and sends the URL information in response to an inquiry from the portable terminal 510.

The above example has been explained for a museum system, in which position information of the real world is detected and relevant information is picked up with infrared ray, but other examples of systems in which relevant information is processed based on position information of the real world include inventory management systems in which barcodes are attached to items in stock and relevant information about these items in stock is picked up by reading the barcodes, or delivery management systems in which barcodes are attached to parcels and packages, the barcodes of the parcels and packages are read whenever they are delivered to a cargo center, so that their delivery can be tracked.

In these conventional position information utilizing systems of the related art, the user uses a portable terminal to enter identification information indicative of the position information in the real world, such as a barcode, radio waves or an infrared transmitter and receiver disposed at the object on display, such as the merchandise or art work, and thus the user can obtain the information that is stored in correlation with the position information. The information that is provided has previously been made available by the store (or the museum). That is to say, only information that is correlated with the position information and that has previously been prepared is provided, and so-called static relevant information can be obtained only passively. The approach of automatically connecting to a certain URL on the internet based on the identified position information and obtaining information from a specified web page also follows basically the same idea.

Thus, the user obtains the information that has been prepared by the store (or museum) only passively, and the design does not provide an active virtual communication space among the users, in which the users actively send information or opinions, give information to other persons sharing the same limited space in the real world, or exchange opinions. As a typical example for which a virtual communication space is desired, a meeting place at which a certain research subject is discussed, such as a research conference, is a limited space in the real world, and it would be very convenient if a virtual (electronic) communication space could be provided in which the people participating in such a meeting can exchange opinions about the subject under discussion in real-time with other participants, regardless of the meeting agenda. At an event such as a data show, a virtual communication space that can be used between participants in this limited space of the world would also be useful as a place for exchanging impressions or opinions about an event in real-time. Furthermore, it would also be useful as a place where spectators at a sports competition or an entertainment facility such as a theater can exchange impressions and opinions in real-time.

Also at places where products are on sale, such as in department stores or shops, places where service is provided, such as restaurants or hotels, it would be very convenient for those who want to know what other users thought about those products or about the service, that is, who want to know so-called word-of-mouth information on the spot and in real-time, if a virtual (electronic) communication space with other users were provided.

In accordance with the present invention, a system for providing a virtual communication space responding to sensed information from the real world provides a virtual communication space in which people seeing, hearing or otherwise experiencing the same thing can exchange impressions and opinions on the spot and in real-time, which is different to communication spaces that are formed between people that do not share the same limited space in the real world, such as conventional forums or electronic bulletin boards, for example on the internet, in non-real-time.

Furthermore, in conventional position information utilizing systems, for supervisors such as meeting place providers, shop owners and service providers, the design did not allow the real-time collecting and display of non-quantifiable opinions and impressions of the customer about the immediate product (or service), or the exchange of so-called word-of-mouth information among customers. In order to grasp the sales situation of a product, POS systems are used, and the popularity of a product (and the inventory control data) are grasped from such numerical data as the sales of that product. Furthermore, the only way to determine why a customer bought the product or how satisfied the customer is with the product is to ask the customer to fill out a questionnaire at a later date or periodically. Therefore, it is not possible to collect the original voices of the customers regarding the product at the point of sale in real-time. In addition to the fact that “the product was sold” and numerical data, it would be very beneficial for a shop owner to learn the opinion of the consumers regarding a product, such as “why wasn't the product sold?”, “what kind of product does the consumer want?” and “what is the price that the consumer wants?”

### DISCLOSURE OF THE INVENTION

In order to solve these problems, it is an object of the present invention to provide a system for providing a virtual communication space, in which people seeing, hearing or otherwise experiencing the same thing can exchange impressions and opinions at the same place (spot) and in real-time, based on information that senses a limited space of the real world. Here, the object also includes that in addition to an exchange of opinions of people who are at the same place (spot) at the same time, impressions and opinions that were left by people who were at that place (spot) within a certain period of the past can be referenced by people participating in the virtual communication space at a later time.

It is also an object of the present invention to provide a system for providing a virtual communication space in which the operator or supervisor of that limited space of the real world can collect in real-time such information as opinions and impressions that are not reflected in the facts and numerical data about the participants.

In order to achieve these objects, a system for providing a virtual communication space, corresponding to sensed information of the real world, between users that have sensed information that is assigned in the real world, includes a communication medium providing a communication channel that makes communication in a limited space of the real world possible; a user terminal including a communication channel identification information sensing means for sensing identification information of a communication channel that has been assigned in that limited space of the real world; a channel login means for selecting a communication channel based on the communication channel identification information; a communication means; a means for inputting information; and a communication application for sending and receiving information via the communication channel; and a virtual communication space providing means including a communication means; a means for grouping user terminals by assigning a communication channel to the user terminals present in the limited space of the real world; a communication channel identification information transmission means for transmitting identification information of the assigned communication channel to the user terminals; a user-sent information storage means for storing information that has been sent by a user terminal; and a user-sent information providing means for providing information stored in the user-sent information storage means to the user terminal logged into the communication channel.

With this configuration, by sensing information that indicates that the user carrying the user terminal is in a limited space of the real world, it is possible to log into a channel that is assigned automatically, and to share a virtual communication space among the users that have sensed that information.

In the system for providing a virtual communication space corresponding to sensed information of the real world in accordance with the present invention, it is preferable that the communication channel identification information transmission means includes a communication channel identification information notifying means for notifying the assigned transmission channel identification information wirelessly, and that the communication channel identification information sensing means is a receiving means sensing communication channel identification information that has been notified wirelessly from the communication channel identification information notifying means.

With this configuration, a user in the limited space of the real world in which wireless communication can be received can log in by obtaining the identification information of the communication channel, and the virtual communication space can be shared among users that have sensed that information.

Here, “wireless” can be any telecommunication, such as radio waves or infrared ray, of any communication standard (IrDA, PHS, etc.), in analog or digital form.

In the system for providing a virtual communication space corresponding to sensed information of the real world in accordance with the present invention, it is preferable that the communication channel identification information transmission means is a communication channel identification information display means for displaying the assigned communication channel identification information, and that the communication channel identification information sensing means is a reading means for reading the communication channel identification information displayed by the communication channel identification information display means.

With this configuration, a user in the limited space of the real world in which the communication channel identification information display means can be detected can log in by obtaining the identification information of the communication channel, and the virtual communication space can be shared among the users sensing that information. Here, the communication channel identification information display means can be anything displaying communication channel identification, such as text, a barcode, an icon, or a symbol.

In the system for providing a virtual communication space corresponding to sensed information of the real world in accordance with the present invention, it is preferable that the user terminal further includes a position detecting means for detecting position information, and the virtual communication space providing means further includes a position/communication channel correspondence table showing the correspondence between position information of the real world and communication channel identification information assigned to places indicated by that position information, and that the communication channel identification information sensing means is a means for notifying the detected position information to the virtual communication space providing means, and sensing the communication channel identification information that is returned based on the position/communication channel correspondence table.

With this configuration, based on the position information that it has detected, the user terminal can detect that it is in the limited space of the real world, check the identification information of the assigned communication information and log in, and thus the virtual communication space can be shared between users that have sensed that information. Here, the “position information” can be any information with which the terminal can detect the device position, such as GPS (global positioning system).

In the system for providing a virtual communication space corresponding to sensed information of the real world in accordance with the present invention, it is preferable that the communication channel login means includes a logout means, and the user terminal logs out of the logged in communication channel to which it is logged in by retiring from the virtual communication space or by logging into a communication channel that is assigned to another virtual communication space.

With this configuration, if a plurality of virtual communication spaces are constructed, and the user moves between the plurality of virtual communication spaces, it is possible to log out automatically from the communication channel of a virtual communication space at a point of origin, and automatically log into a communication channel of a virtual communication space at a point of destination.

In the system for providing a virtual communication space corresponding to sensed information of the real world in accordance with the present invention, it is preferable that the user-sent information providing means provides user-sent information by posting information on an electronic bulletin board that is maintained for a certain period of time.

With this configuration, a user that has entered a new virtual communication space can see the conversation by letter that has already taken place among users in that space. For example, it is possible to ensure a certain time margin for a foreigner to comprehend an unfamiliar local language, or a certain time margin can be ensured for information input/output by persons that are perceptively challenged, such as handicapped persons.

In the system for providing a virtual communication space corresponding to sensed information of the real world in accordance with the present invention, it is preferable that the user-sent information providing means provides user-sent information by providing all user-sent information that has been accumulated as history of a predetermined period of time prior to login to user terminals that have newly logged into the communication channel, and thereafter immediately exchanging user-sent information among users that are logged in as chat.

With this configuration, the users sharing the virtual communication space can hold a conversation in real-time, as in an ordinary conversation, and it is possible to ensure its convenience and responsiveness as a means of communication.

It is preferable that the system for providing a virtual communication space corresponding to sensed information of the real world in accordance with the present invention further includes a supervisor terminal outside the limited space of the real world; that the communication means includes an external communication means for external communication with the supervisor terminal; and that the supervisor terminal includes a channel login means for logging into the communication channel on which communication has become possible with the external communication means, and a communication application for sending and receiving information via the communication channel, wherein information can be sent and received among user terminals in the limited space of the world via the virtual communication space providing means.

With this configuration, by ensuring the communication means for communicating outside the limited space of the real world, the flexibility of the system operation using the virtual communication space is increased, and for example, a participant in an electronic conference system can share the virtual communication space by participating remotely in a research conference for example.

In the system for providing a virtual communication space corresponding to sensed information of the real world in accordance with the present invention, it is preferable that the supervisor terminal includes a user-sent information monitoring means for monitoring user-sent information that is stored by the user-sent information storage means.

With this configuration, if, for example, the system supervisor wants to benefit from the virtual communication space by after-processing, then the system supervisor can collect the opinions and impressions of the users, and if this system is used in a shop, it is possible to collect the customers' opinions with regard to products and services that cannot be obtained ordinarily, which is very advantageous for marketing.

In the system for providing a virtual communication space corresponding to sensed information of the real world in accordance with the present invention, it is preferable that the supervisor terminal further includes a user-sent information collecting means for collecting a log of the sent records of user-sent information that has been stored by the user-sent information storage means, and a user-sent information database accumulating the user-sent information that has been collected.

With this configuration, the user's opinions and impressions can be collected comprehensively, and if this system is used in a shop, it is possible to collect the customers' opinions with regard to products and services that cannot be obtained ordinarily, and a database can be created by accumulating the collected user-sent information.

In the system for providing a virtual communication space corresponding to sensed information of the real world in accordance with the present invention, it is preferable that the supervisor terminal further includes a keyword classification means for classifying by keyword the content of the user-sent information in the user-sent information database, a user-sent information analyzing means for analyzing statistical qualities of the user-sent information that has been classified by keyword, and a direct electronic mail sending means for sending information that is associated with the keyword classification to the user terminal that has sent the user-sent information that has been classified by keyword.

With this configuration, it is possible to convert the collected customer opinion information into text data, extract keywords from the text data, and analyze statistical qualities by keyword classification, and the collecting of questionnaires grasping orientation and needs of the customers can be performed automatically by grasping tendencies in the opinions of the users in the limited space of the world. If the collected customer opinion information is in form of voice data, then the voice data are recognized by an voice recognition system. The keyword extraction can be performed by morpheme analysis or syntactical analysis. Based on this analysis, it is possible to send direct electronic mail in accordance with the information desired by the user, as well as the user's interests and needs, as determined from the user's opinions and impressions, and used in a shop, this is very advantageous to enhance sales or marketing.

A computer-readable storage medium storing a program for realizing a system for providing a virtual communication space between users that have sensed information that is shared in the real world, the storage medium includes a communication control program for controlling a communication means for providing a communication channel that makes communication in a limited space of the real world possible; a user terminal processing program including a processing operation of sensing identification information of communication channels that have been provided by the communication means; a channel login processing operation of switching communication channels based on the communication channel identification information; and a communication application for sending and receiving information via the communication channel; a virtual communication space providing processing program including a processing operation of logging into user terminals by a assigning communication channel to user terminals present in the limited space of the real world; a communication channel identification information transmission processing operation of transmitting identification information of an assigned communication channel to a user terminal; a user-sent information storage processing operation of storing information that has been sent by a user terminal via the communication channel; and a user-sent information providing processing operation of providing information stored in the user-sent information storage processing operation to the user terminal accessible via the communication channel.

With this configuration, it is possible to provide a virtual communication space corresponding to sensed information of the real world, using a computer, such as a personal computer or a work station.

In the computer-readable storage medium storing a program for realizing a system for providing a virtual communication space corresponding to sensed information of the real world in accordance with the present invention, it is preferable that the storage medium further includes a processing program for a supervisor terminal that is outside the limited space of the real world; that the communication control program further includes an external communication control program controlling external communication with the processing program for the supervisor terminal; and that the processing program for the supervisor terminal includes a channel login processing operation of logging into the communication channel with which the external communication program has enabled communication, and a communication application for sending and receiving information via the communication channel, and wherein the processing program for the supervisor terminal can exchange information with the processing programs for the user terminals in the limited space of the real world via the virtual communication space providing processing program.

With this configuration, it is possible to provide a virtual communication space, corresponding to sensed information of the real world, that further includes terminals outside that space, using a computer, such as a personal computer or a work station.

In accordance with the present invention, in the system for providing a virtual communication space, corresponding to sensed information of the real world, it is preferable that the information that is sent and received includes text information, voice information or image information. The users sharing the virtual communication space can use various kinds of communication media.

### BRIEF DESCRIPTION OF THE DRAWINGS

FIG. 1 illustrates the principle of the system for providing a virtual communication space of Embodiment 1 of the present invention.

FIG. 2 diagrammatically illustrates the configuration of the system for providing a virtual communication space of Embodiment 1 of the present invention.

FIG. 3 is a flowchart showing the overall aspects of the process flow in the system for providing a virtual communication space of Embodiment 1 of the present invention as processing operations.

FIG. 4 diagrammatically illustrates the configuration of the system for providing a virtual communication space of Embodiment 2 of the present invention.

FIG. 5 is a flowchart showing the overall aspects of the process flow in the system for providing a virtual communication space of Embodiment 2 of the present invention as processing operations.

FIG. 6 illustrates the principle of the system for providing a virtual communication space of Embodiment 3 of the present invention.

FIG. 7 diagrammatically illustrates the configuration of the system for providing a virtual communication space of Embodiment 3 of the present invention.

FIG. 8 is a flowchart showing the overall aspects of the process flow in the system for providing a virtual communication space of Embodiment 3 of the present invention as processing operations.

FIG. 9 diagrammatically illustrates the configuration of a cart built-in type user terminal 20a.

FIG. 10 is a flowchart showing the overall aspects of the process flow in the system for providing a virtual communication space of Embodiment 1 of the present invention as processing operations.

FIG. 11 shows an example of a storage medium storing a processing program of a system for providing a virtual communication space.

FIG. 12 illustrates the principle of a conventional museum system.

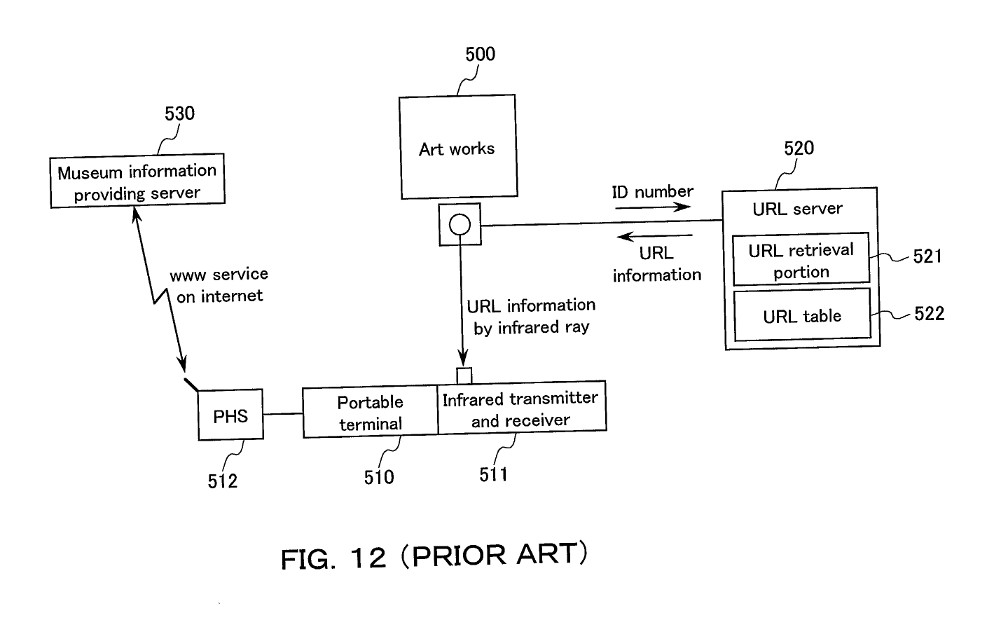

### BEST MODE FOR CARRYING OUT THE INVENTION

Referring to the accompanying drawings, the following is an explanation of embodiments of a system for providing a virtual communication space responding to sensed information of the real world in accordance with the present invention.

Embodiment 1

In the system for providing a virtual communication space according to Embodiment 1 of the present invention, the user carries a user terminal, a virtual communication space is identified with the information that can be sensed by the user terminal in a limited space of the real world, and the provided virtual communication space is automatically provided. This Embodiment 1 is explained with an example in which the sensed information is identification information that is sent and received wirelessly.

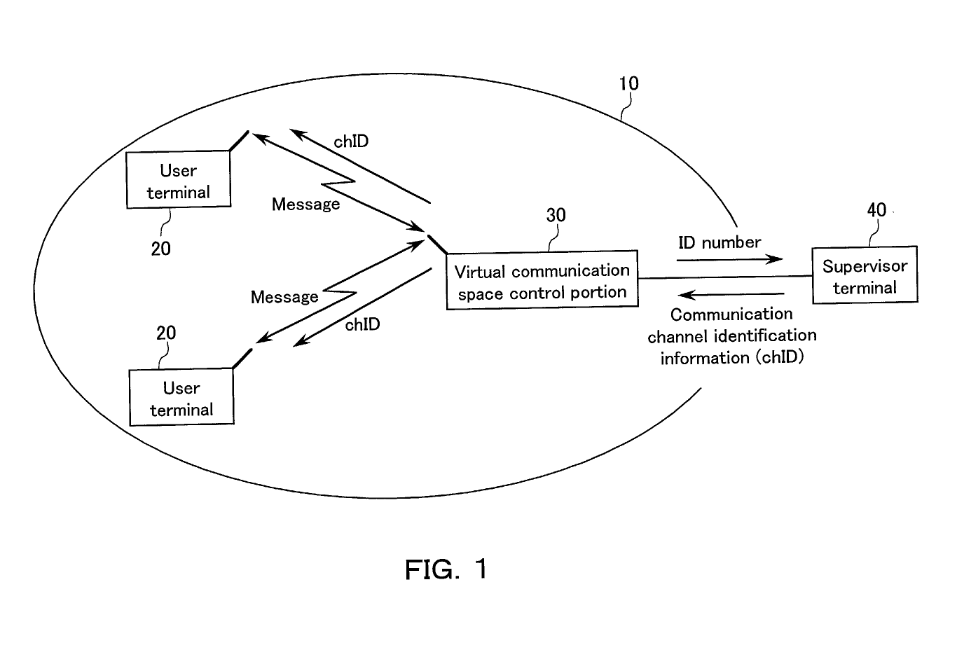

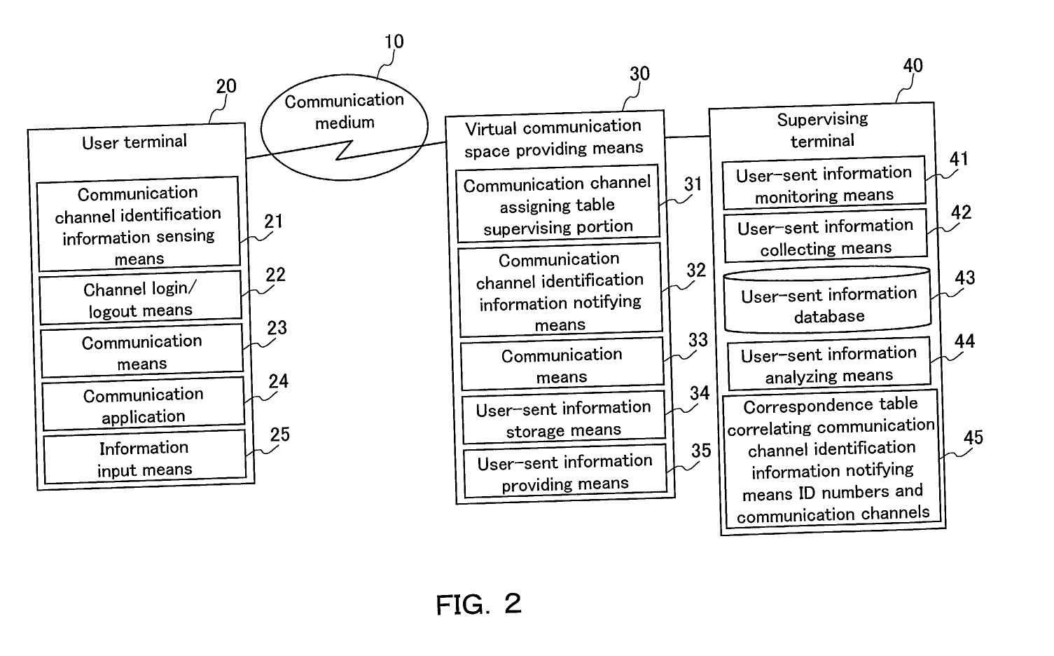

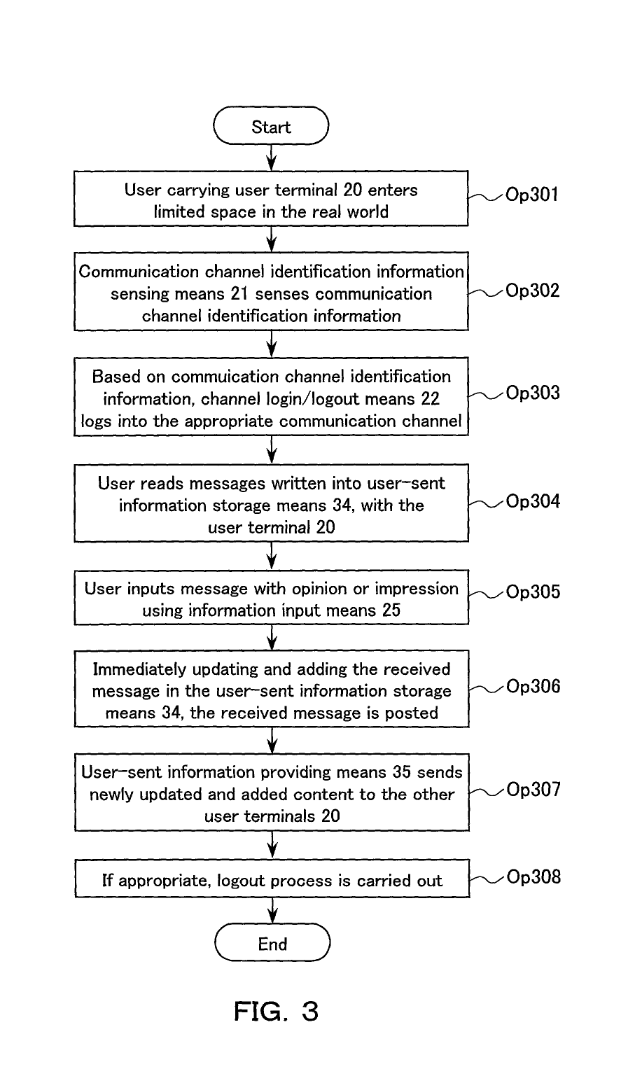

FIG. 1 illustrates the principle of the system for providing a virtual communication space of Embodiment 1, and FIG. 2 diagrammatically illustrates the configuration of the system for providing a virtual communication space of Embodiment 1. FIG. 3 is a flowchart showing the overall aspects of the process flow in this system as processing operations.

FIG. 1 illustrates the principle by which a system for providing a virtual communication space is organized wirelessly in a limited space of the real world. A virtual communication space providing means 30 includes a communication antenna, and has an area in which wireless reception is possible. This area amounts to a communication medium 1. By employing a plurality of virtual communication space providing means 30, it is possible to provide a plurality of virtual communication spaces. The communication medium 10 is shared by user terminals 20 having a communication antenna. In the background, there is a supervisor terminal 40. The detailed configuration of these elements is explained further below with reference to FIG. 2. In the following, the principle is outlined in a simple fashion.

An identification number, such as an ID number, is given to a communication channel identification information notifying means 32 of the virtual communication space providing means 30, and the supervisor terminal 40 assigns to each communication channel identification information notifying means 32 a communication channel based on a correspondence table 45 for communication channel identification information notifying means ID numbers and communication channels, and sends communication channel identification information assigning the corresponding virtual communication space. The virtual communication space providing means 30 notifies that the communication channel identification information to all user terminals 20 sharing the communication medium 10. The user terminals 20 perform a login based on that communication channel identification information, and using that communication channel, messages can be exchanged in the constructed virtual communication space among the user terminals 20, utilizing applications such as electronic bulletin boards or so-called “chatting”, with the virtual communication space providing means 30 as the server. If the user terminals monitor the messages through their own communication channels, it is possible to collect and analyze the users' opinions and impressions. The above explanations sum up the basic principle of the present invention.

The following is an explanation of the configuration of the system for providing a virtual communication space of Embodiment 1 of the present invention. Broadly speaking, the system for providing a virtual communication space includes a communication medium 10 providing a communication channel, a user terminal 20, a virtual communication space providing portion 30 controlling the virtual communication space providing means, and a supervisor terminal 40. Although this is not shown in the drawings, the system for providing a virtual communication space also includes the controllers and memory necessary for the control processes of the entire system.

In this embodiment, the communication medium 10 is a space that is suitable for wireless communication, because the virtual communication space is constructed by wireless communication. If necessary, the communication medium 10 can also include wireless repeaters. As explained below, the virtual communication space providing portion 30 assigns a specified frequency to each virtual communication space, creating a medium for providing a virtual communication space between the plurality of user terminals 20.

The user terminals 20 include a communication channel identification information sensing means 21, a channel login/logout means 22, a communication means 23, a communication application 24, and an information input means 25. Here, the communication channel identification information sensing means 21 senses identification information of communication channels that is sent by the virtual communication space providing portion 30. Due to the communication channel identification information sensing means 21 sensing the identification information, the user terminals 20 are in a limited space of the real world, and can identify the communication channels assigned as the virtual communication space. The channel login/logout means 22 includes a means for logging into the communication channel based on the channel identification information obtained by the communication channel identification information sensing means 21 when the user terminal 20 has entered the virtual communication space, and a means for logging out of the communication channel when leaving that virtual communication space. By logging in with the channel login/logout means 22, the user terminal 20 becomes a member of the shared virtual communication space (participation), and by logging out, it stops to share in the virtual communication space (retirement). The communication means 23 is a means for undertaking communication with other parties sharing the virtual communication space, and in Embodiment 1, it is a means for sending and receiving information wirelessly. The communication application 24 is an application software program for controlling/utilizing communication with the virtual communication space as a medium. The information input means 25 is an interface for information input into the user terminal 20.

The virtual communication space providing portion 30 defines the limited space of the real world and assigns a communication channel of specified frequency to the user terminals 20 in that space, thus providing and supervising the virtual communication space. The virtual communication space providing portion 30 includes a communication channel assigning table supervising portion 31, a communication channel identification information notifying means 32, a communication means 33, a user-sent information storage means 34, and a user-sent information providing means 35. The communication channel assigning table supervising portion 31 assigns a communication channel to each virtual communication space 30, supervises the login (participation) and logout (retirement) of the user terminals 20 with respect to each virtual communication space 30, and supervises the table grouping the user terminals 20. The communication channel identification information notifying means 32 is a communication channel identification information transmission means, which, in Embodiment 1, sends/notifies the communication channel identification information wirelessly to a limited area. It should be noted that the limited space of the real world, which is the wireless reception area, can be defined by adjusting its wireless transmission capability, and the notified communication channel identification information serves as sensed information of the real world. In Embodiment 1, the communication means 33 is a means for sending and receiving data wirelessly, which carries out the sending and receiving of data among the user terminals 20, after the user terminals 20 have logged into their communication channel. The user-sent information storage means 34 is a storage device, such as a memory or a hard disk, for temporarily storing messages that have been sent by the user terminals 20, and the user-sent information providing means 35 has the function to send/provide the data of the user-sent information storage means 34 to the user terminals 20. In Embodiment 1, the communication performed in the virtual communication space does not take the form of electronic mail among the user terminals 20 with a specified communication partner, but the form of communication by a temporary electronic bulletin board that is provided dynamically among the parties sharing the actual space. So-called chat communication between the user terminals 20 is also an appropriate application form. It should be noted that this does not preclude communication by electronic mail with specified communication partners among the user terminals 20.

The supervisor terminal 40 includes a user-sent information monitoring means 41, a user-sent information collecting means 42, a user-sent information database 43, a user-sent information analyzing means 44, and a correspondence table 45 correlating communication channel identification information notifying means ID numbers and communication channels. The supervisor terminal 40 monitors messages exchanged in the virtual communication space with the user-sent information monitoring means 41, and collects message logs with the user-sent information collecting means 42. The collected messages are accumulated in the user-sent information database 43, and the message content is analyzed and classified by after-processing with the user-sent information analyzing means 44. By collecting, classifying and analyzing the messages, the customers' unfettered opinions and impressions can be collected, and the customers' needs and satisfaction can be enhanced. Moreover, with the correspondence table 45 correlating communication channel identification information notifying means ID numbers and communication channels it is possible to supervise the correspondence between the ID numbers of the communication channel identification information notifying means located in the virtual communication spaces and the assigned communication channels, and by rewriting the content of that table, the supervisor terminal can freely set and supervise the virtual communication spaces.

FIG. 3 is a flowchart showing, as processing operations, an outline of the flow by which the system for providing a virtual communication space constructs and controls a virtual communication space.

First, a user carrying a user terminal 20 moves in the real world, and enters the limited space in the real world that is controlled and supervised by the virtual communication space providing portion 30 (Operation Op 301).

The communication channel identification information notifying means 32 sends out wirelessly communication channel identification information into the space. The area in which this communication channel identification information can be received is the limited space of the real world. The communication channel identification information is received and sensed by the communication channel identification information sensing means 21 of the user terminal 20 (Operation Op 302).

Based on the sensed communication channel identification information, the user terminal 20 logs into the corresponding channel with the channel login/logout means 22 (Operation Op 303). By logging in, it shares into the virtual communication space provided by the virtual communication space providing portion 30. The communication channel assigning table supervising portion 31 adds/updates the newly logged in user terminal 20 to the communication channel assigning table, and groups/supervises the user terminals 20 that are present in the provided/supervised virtual communication space.

The user terminals 20 and the virtual communication space providing portion 30 communicate with one another with their respective communication means 23 and communication means 33. The virtual communication space providing portion 30 uses the communication means 33, the user-sent information storage means 34 and the user-sent information providing means 35 to provide a so-called electronic bulletin board, and a so-called chat application in which a plurality of persons can participate. When used it as an electronic bulletin board, the user picks up, with the user terminal 20, the message content that has been written into the user-sent information storage means 34 (Operation Op 304). With the information input means 25, the user inputs a message, such as an opinions or impression or question to the supervisor regarding the content the user has viewed in that limited space of the real world, and sends off the message (Operation Op 305). This can also be an opinion or impression regarding a message already posted on the electronic bulletin board. Immediately updating and adding the message received from the user terminal 20 in the user-sent information storage means 34, the virtual communication space supervising portion 30 posts the received message (Operation Op 306). Then it sends the newly updated or added information to the other logged in user terminals 20 with the user-sent information providing means 35 (Operation Op 307). By enhancing the responsiveness of the updating and adding of messages of a plurality of people to immediate responses, the system can serve as a so-called chat service. When the user terminal 20 moves and leaves the virtual communication space, it performs a logout process (Operation Op 308) from the communication channel. At least the following two methods can be given as examples of a logout process by the user terminal 20. One method of logging out from the channel is to continuously receive with the communication channel identification information sensing means 21 at constant intervals communication channel identification information sent out wirelessly by the communication channel identification information notifying means 32, and when reception is impossible, the channel login/logout means 22 determines that the virtual communication space has been left. Another method of logging out from the channel is that when the user terminal moves and enters another virtual communication space, and the communication channel identification information emitted by the communication channel identification information notifying means 32 of the other virtual communication space is sensed by the communication channel identification information sensing means 21, then the channel login/logout means 22 determines that the virtual communication space has been left. If the communication channel identification information is obtained, as explained below in Embodiment 2, by reading a communication channel identification information display means 32a such as a barcode with a communication channel identification information sensing means 21a such as a barcode reader, then the later logout process is given. Moreover, when the logout from the side of the user terminal 20 is notified to the logout process on the side of the supervisor terminal 40, the communication channel assigning table supervising portion 31 deletes the user terminal that has logged out from the communication channel assigning table.

The above is an outline of the process flow of the system for providing a virtual communication space.

The following explains an application example of this system for providing a virtual communication space on the side of a system supervisor (such as a store or an event organizer).

A virtual communication space that is provided and applied with the above-described procedure can also be implemented with high application value on the system supervisor side.

With the user-sent information monitoring means 41, the supervisor terminal 40 can monitor the communication by electronic bulletin board or chatting that is exchanged in the virtual communication space. With this monitoring function, it is possible to collect original opinions from customers or participants, that ordinarily cannot be collected directly. It is usually tried to grasp the customers' needs by service personnel, yet mostly it is difficult to collect the customers' unfettered opinion or impressions. But with the communication exchanged in this virtual communication space, the user's sense of participation is that of a free and open exchange of opinions and impressions between the users, or that of a casual chat in the street, and it becomes possible to collect the customers' or users' frank opinions and impressions, or, if the function of sending (replying) information by their own is provided, it is possible to provide answers to questions or complaints brought on by the customer.

Moreover, the supervisor terminal 40 collects a message log with the user-sent information collecting means 42, and accumulates this message log in the user-sent information database 43. The user-sent information database 43 creates a precious business asset for the system supervisor. Furthermore, the message contents can be analyzed with the user-sent information analyzing means 44 by after-processing. There is no particular limitation to the analyzing method, and computer-based analyzing tools can be used. For example, first, when a message is not given as text information but as voice information, the voice information is converted by a voice recognition tool into text information. Then, for the classification of the text information, the system supervisor side classifies the opinions into predetermined classes, typically by word-level analysis (morpheme analysis) and semantic analysis. It should be noted that it is also possible that monitoring personnel classifies the messages.

In the above configuration, the communication channel identification information is transmitted by radio waves between the communication channel identification information sensing means 21 and the communication channel identification information notifying means 32, but instead of by radio waves, it can also be transmitted by an infrared communication link. The communication channel identification information sensing means 21 and the communication channel identification information notifying means 32 should be able to transmit the communication channel identification information in accordance with a standard as IrDA. In that case, the directionality is high, so that this adds the task of the user adjusting to the directionality of the interface of the infrared communication link.

The system for providing a virtual communication space of Embodiment 1 as explained above can constructs the virtual communication space automatically based on information that the user terminal carried by the user can sense in a limited space of the real world. It further provides a virtual communication space that can serve as a place to freely and openly exchange opinions between user terminals in the limited space of the real world, and the system supervisor can collect and analyze unfettered opinions that are exchanged between the users.

Embodiment 2

In Embodiment 2, an example is explained, in which the sensed information is displayed by a display means, such as a tag expressing the communication channel identification information as a barcode or alphanumeric characters, and the communication channel identification information is obtained by reading that display means with the user terminal.

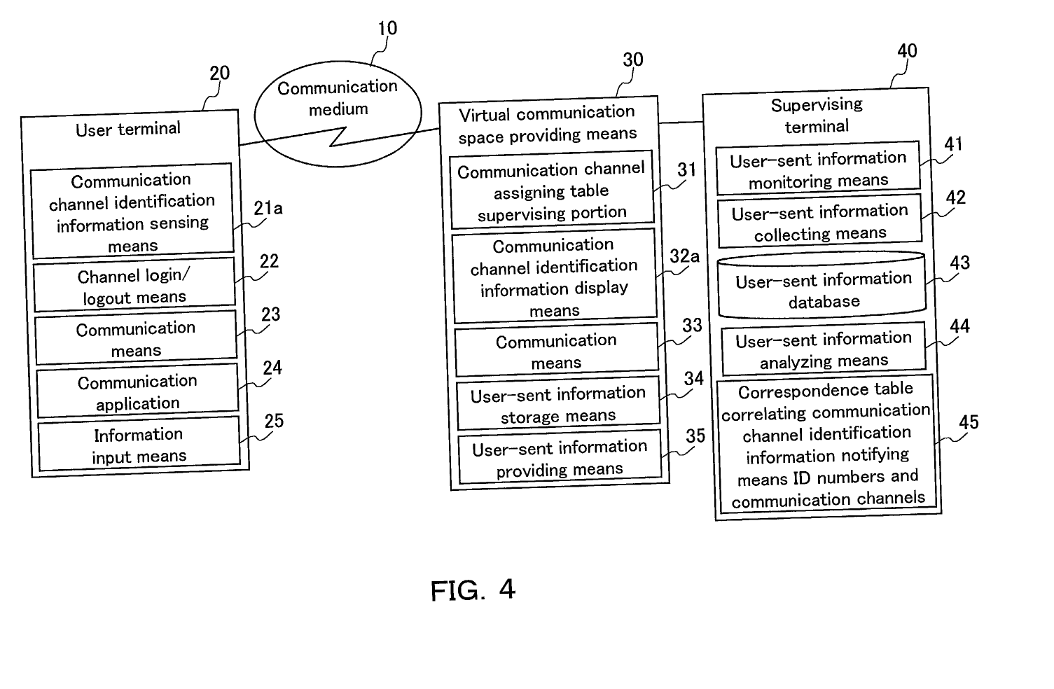

FIG. 4 diagrammatically illustrates the configuration of a system for providing a virtual communication space according to Embodiment 2. As in Embodiment 1, this system for providing a virtual communication space includes broadly speaking a communication medium 10 providing a communication channel, a user terminal 20, a virtual communication space providing portion 30 that is a virtual communication space providing means, and a supervisor terminal 40, but the virtual communication space providing portion 30 includes a communication channel identification information display means 32a instead of a communication channel identification information notifying means, and the communication channel identification information sensing means 21a of the user terminal 20 has the function to read the communication channel identification information display means 32a. Here, the communication channel identification information display means 32a is typically a barcode, and the communication channel identification information sensing means 21a has a barcode reading function. Alternatively, the communication channel identification information display means 32a has the communication channel identification information written as a code of alphanumerical characters, and the communication channel identification information sensing means 21a has an OCR (optical character recognition) function.

Other elements in FIG. 4 are the same as shown in FIG. 2 of Embodiment 1, so that their further explanation has been omitted here. Also, the controllers and memory necessary for process control of the overall system are provided.

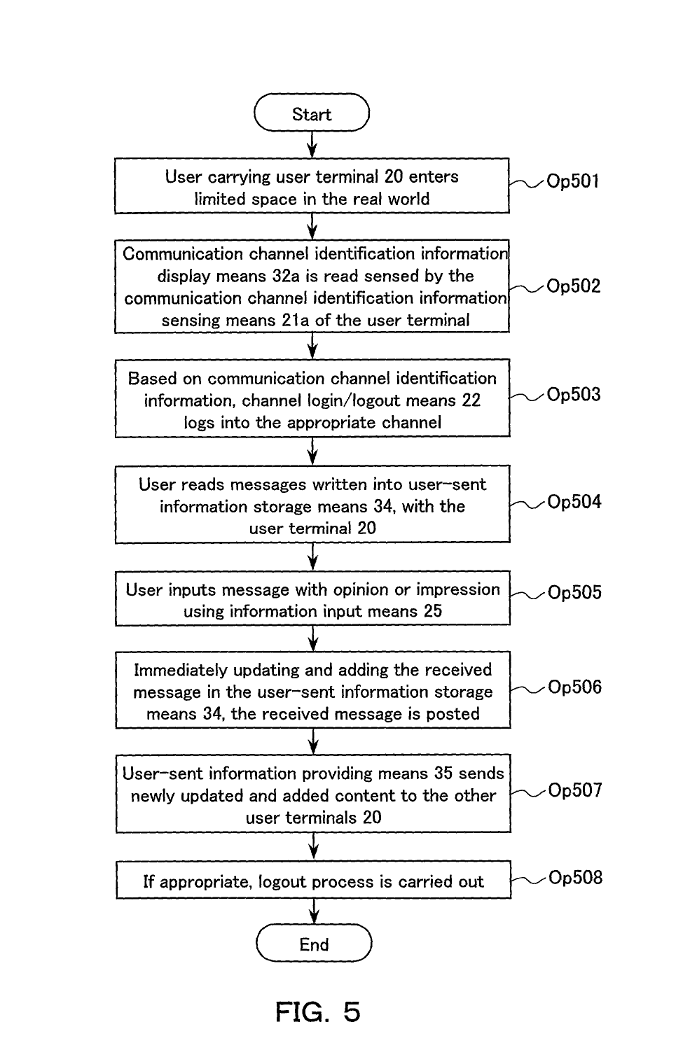

FIG. 5 is a flowchart showing, as processing operations, an outline of the flow by which the system for providing a virtual communication space constructs and controls a virtual communication space.

First, a user carrying a user terminal 20 moves in the real world, and enters the limited space in the real world that is controlled and supervised by the virtual communication space providing portion 30 (Operation Op 501).

The virtual communication space providing means 30 and the communication channel identification information display means 32a are placed in the limited space in the real world. For example, in the case of a conference room for a research conference, a barcode of the communication channel identification information can be displayed near the entrance, in addition to the name of the meeting. In the case of a locality for exhibiting merchandise, such as a store, it is conceivable to attach tags displaying the barcode of the communication channel identification information near the merchandise. The communication channel identification information display means 32a is sensed by reading with the communication channel identification information sensing means 21a of the user terminal 20 (Operation Op 502). When a user has read the communication channel identification information display means 32a, this means that the user is present in that limited space in the real world, and the communication channel identification information assigned to that space becomes the sensed information.

The following operations Op 503 to Op 508 are similar to the operations Op 303 to Op 308 of the process flow shown in FIG. 3, so that their further explanations have been omitted.

In the system for providing a virtual communication space of this Embodiment 2, the transmission of the communication channel identification information is not carried out wirelessly but by tags displaying code information, such as a barcode or alphanumeric characters, and the device configuration can be simplified.

Embodiment 3

The system for providing a virtual communication space of Embodiment 3 of the present invention measures and senses the position in the real world of the user carrying the user terminal by GPS (global positioning system), identifies the corresponding virtual communication space with the position information due to the GPS as the sensed information, and constructs the virtual communication space automatically. Of course, the system is used in an environment in which the GPS from the GPS satellites can be effectively received, such as outside.

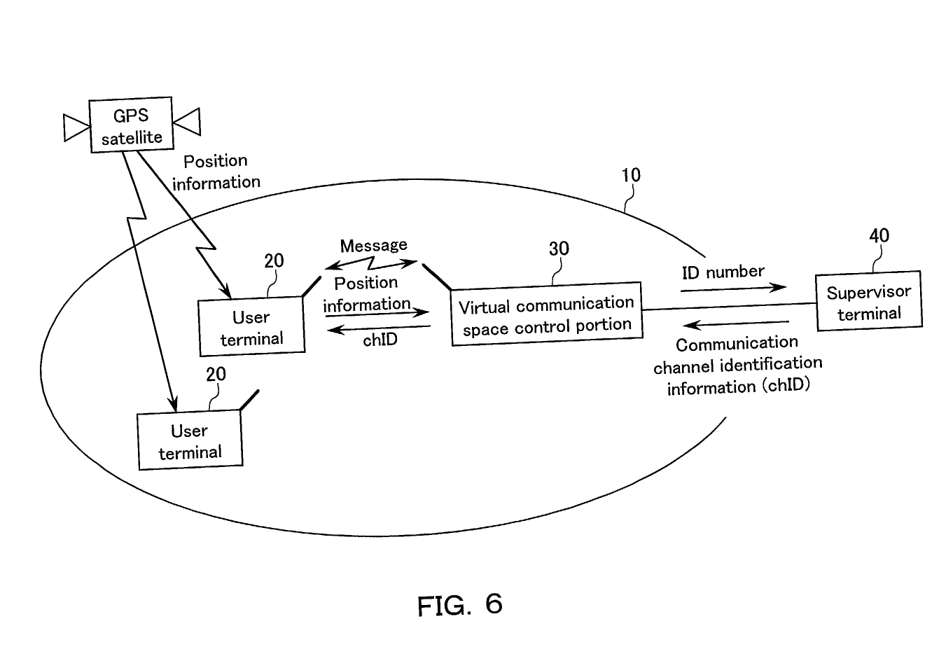

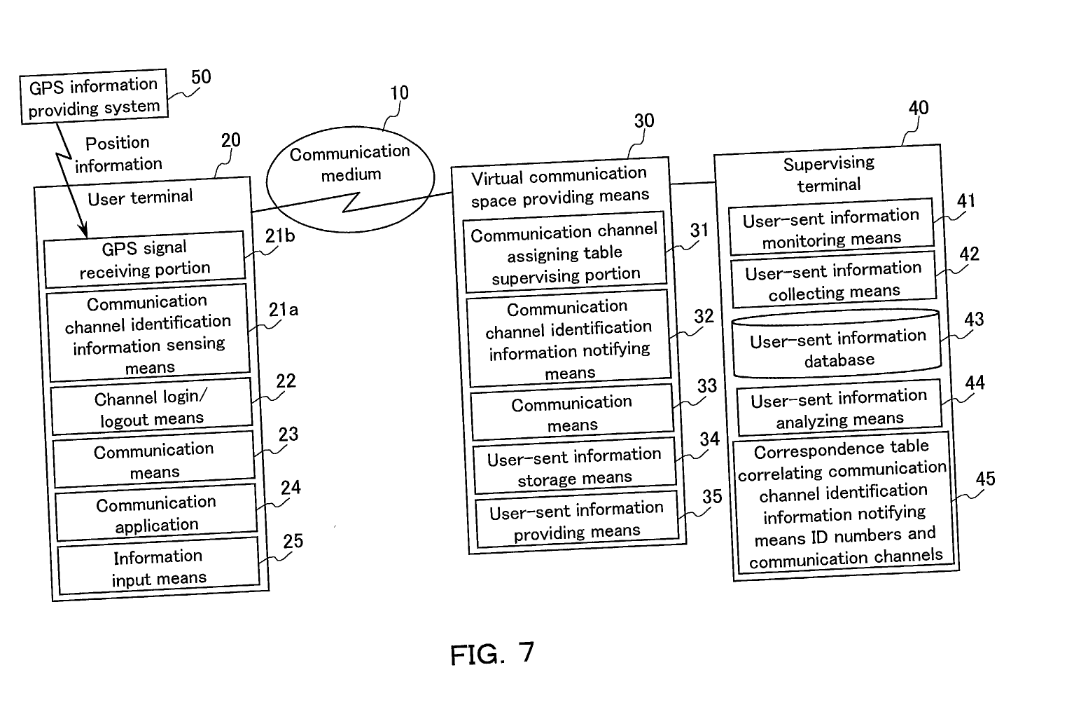

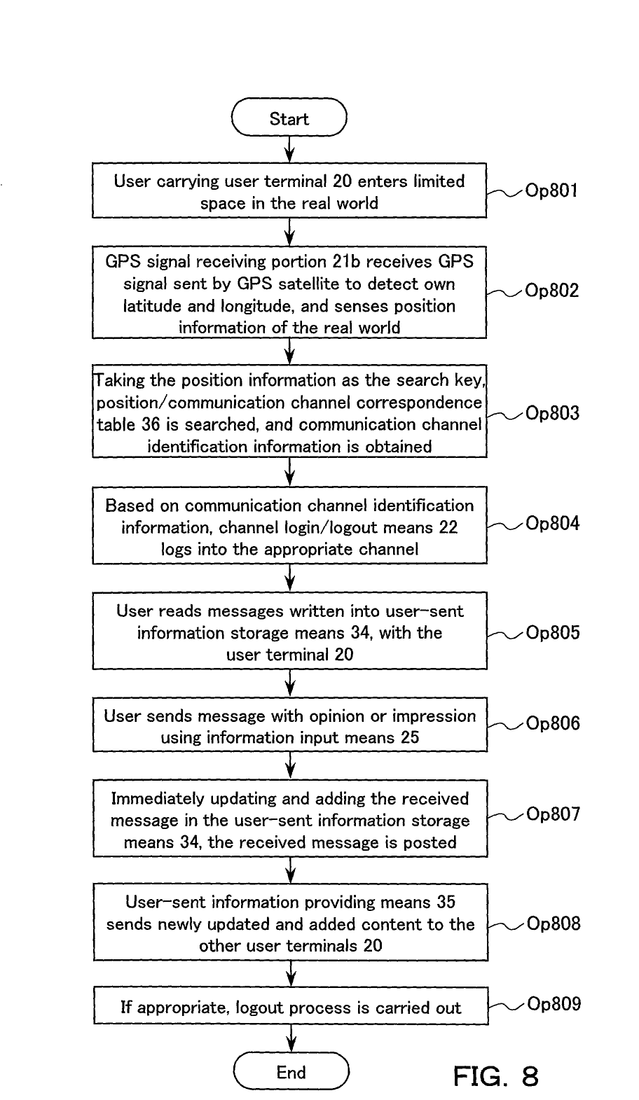

FIG. 6 illustrates the principle of the system for providing a virtual communication space of Embodiment 3, and FIG. 7 diagrammatically illustrates the configuration of the system for providing a virtual communication space of Embodiment 3. FIG. 8 is a flowchart showing the overall aspects of the process flow in this system as processing operations.

FIG. 6 illustrates the principle by which position information in the real world is detected by GPS, and that position information is used to organize a system for providing a virtual communication space. The user terminal 20 has a GPS signal reception antenna, and detects its position on earth based on the signal sent by a GPS satellite 5. A virtual communication space providing portion 30 having a virtual communication space providing means includes a communication antenna, and has an area in which radio reception is possible. This area amounts to a communication medium 10. This communication medium 10 is shared by the user terminals 20 having a communication antenna. In the background, there is a supervisor terminal 40. The supervisor terminal 40 obtains an identification number of the virtual communication space providing portion 30, and provides communication channel identification information assigned to the virtual communication space provided by the virtual communication space providing portion 30. The user terminal 20 notifies the detected position information to the virtual communication space providing means 30. The virtual communication space providing portion 30 holds a conversion table with position information and identification information of the communication channels assigned to the virtual communication provided in the area belonging to that position. The virtual communication space providing means 30 notifies to the user terminals 20 the corresponding communication channel identification information based on the position information notified by the user terminal 20. The user terminals 20 perform a login based on that communication channel identification information, and using that communication channel, messages can be exchanged in the virtual communication space provided between the user terminals 20, utilizing such applications as electronic bulletin boards or so-called “chatting” with the virtual communication space providing means 30 as the server. If the user terminals 20 monitor the messages through their own communication channels, it is possible to collect and analyze the users' opinions and impressions. The above explanations sum up the basic principle of Embodiment 3.

The following is an explanation of the configuration of the system for providing a virtual communication space of Embodiment 3 of the present invention. Broadly speaking, the system for providing a virtual communication space includes a communication medium 10 providing a communication channel, a user terminal 20, a virtual communication space providing portion 30 that is a virtual communication space providing means, a supervisor terminal 40, and additionally a GPS information providing system 50 including satellites for GPS or the like. The user terminals 20 include a GPS signal receiving portion 21b serving as a position detection means. The virtual communication space providing portion 30 includes a position/communication channel correspondence table 36 correlating position information and communication channel identification information. Other elements in FIG. 7 are the same as shown in FIG. 2 of Embodiment 1, so that their further explanation has been omitted here. Also, the controllers and memory necessary for process control of the overall system are provided.

The GPS sends a predetermined GPS signal from a plurality of satellites positioned around the earth, and latitude and longitude on the earth can be detected with precision by a receiver based on the GPS signal received on the receiving side. In Embodiment 3, the user terminals 20 can detect latitude and longitude precisely with the GPS information providing system 50 and the GPS signal receiving portions 21b of the user terminals 20. The user terminals 20 notify the detected position information to the virtual communication space providing portion 30 with their communication means 23. The virtual communication space providing portion 30, which includes a position/communication channel correspondence table 36, retrieves the communication channel identification information based on the position information received from the user terminals 20, and sends the corresponding communication channel identification information back to the user terminals 20 via the communication channel identification information notifying means 32. In other words, the communication channel identification information can be obtained a GPS signal as the sensed information.

FIG. 8 is a flowchart showing, as processing operations, an outline of the flow by which the system for providing a virtual communication space of Embodiment 3 constructs and controls a virtual communication space.

First, a user carrying a user terminal 20 moves in the real world, and enters the limited space in the real world that is controlled and supervised by the virtual communication space providing portion 30 (Operation Op 801).

The user terminal 20 receives with the GPS signal receiving portion 21b the GPS signal sent from the GPS satellite, and detects its own latitude and longitude, sensing the position information of the real world (Operation Op 802).

Then, the user terminal 20 sends the position information obtained at operation 802 to the virtual communication space providing portion 30, which searches the position/communication channel correspondence table 36 with that position information as the search key, obtaining the assigned communication channel identification information (Operation Op 803). It is preferable that the virtual communication space providing portion 30 acquires and stores the position/communication channel correspondence table 36 beforehand from the organizer of the research conference or the supervisor of the store or the like.

The following operations Op 804 to Op 808 are similar to the operations Op 303 to Op 308 in FIG. 3 as explained for Embodiment 1, so that their further explanations have been omitted.

As mentioned above, the system for providing a virtual communication space of Embodiment 2 makes use of the GPS system to sense the position information of the user terminal carried by the user in the real world, and the virtual communication space can be provided by obtaining the corresponding communication channel identification information.

Embodiment 4

The system for providing a virtual communication space of Embodiment 4 of the present invention is corresponding to stores for example, and the user terminals are provided as cart-type terminal by the store. Basically, the user terminals 20 of the above-described Embodiments 1 to 3 are replaced with cart-type user terminals, and the following example explains a system for providing a virtual communication space that transmits communication channel identification information wirelessly, as shown in Embodiment 1.

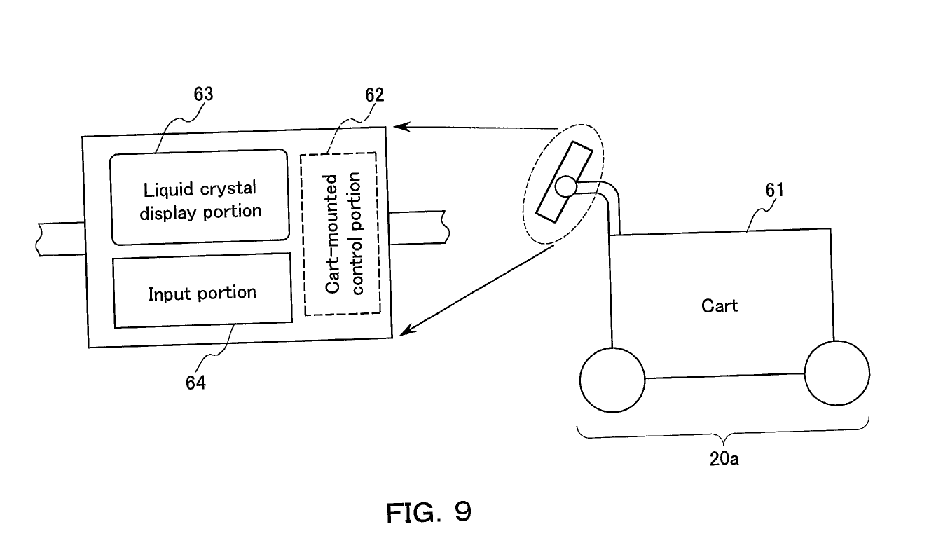

FIG. 9 is a diagram outlining the configuration of a cart-type user terminal 20a. The cart 61 includes a cart-mounted control terminal 62 including a communication channel identification information sensing means 21, a channel login/logout means 22, a communication means 23, and a communication application 24, as well as a liquid crystal display portion 63 arranged in the cart handle, and an input portion 64. Basically, the user terminal explained for Embodiment 1 is attached in one piece to the cart 61. The liquid crystal display portion 63 and the input portion 64 should be arranged at an easily accessible position.

The store has to define the sales areas displaying the same merchandise, such as certain product sales spots, as limited spaces of the real world. These spaces are laid out, a virtual communication space providing portion 30 is set up for each space, and the access regions of the radio signals are controlled by regulating the radio output capability so that the virtual communication space providing portions 30 do not interfere with the virtual communication space providing portions 30 of the other adjacent sales spots. If necessary, the walls and product display shelves are provided with electromagnetic shields, thus creating a limited space of the real world at each product sales spot.

Other elements, such as the communication medium 10, the user terminal 20, the virtual communication space providing portion 30 and the supervisor terminal 40 can be as explained for Embodiment 1, so that their further explanation is omitted.

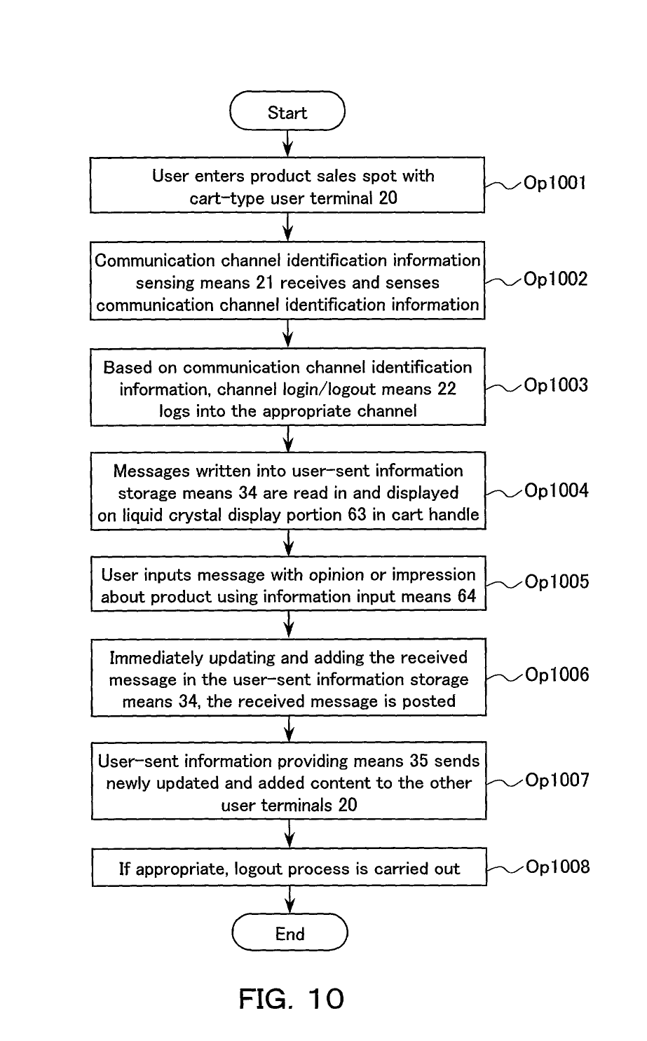

An outline of the processing operations in the system for providing a virtual communication space of Embodiment 4 is shown in the flowchart of FIG. 10.

Buying merchandise as always, the user moves between the product sales spots pushing the cart 61. That is to say, the user moves together with the cart-type user terminal 20a. Then the user and the cart-type user terminal 20a enter a product sales spot controlled and supervised by a certain virtual communication space providing portion 30 (Operation Op 1001).

With the communication channel identification information notifying means 32, the virtual communication space providing portion 30 sends out communication channel identification information into that space. Here, it is controlled such that the information is not mixed with the communication channel identification information sent out in the neighboring product sales spots, so that the communication channel identification information sensing means 21 of the cart-type user terminal 20a receives and senses that communication channel identification information (Operation Op 1002).

Based on the communication channel identification information serving as the sensed information, the channel login/logout means 22 logs into that channel (Operation Op 1003). With the login, the virtual communication space provided by the virtual communication space providing portion 30 is shared.

Using the communication means 23, the cart-type user terminal 20a picks up the message content written into the user-sent information storage means 32, and displays it on the liquid crystal display portion 63 in the cart handle (Operation Op 1004). Embodiment 4 is useful in that the store can distribute information about the merchandise or about special bargains, in addition to messages among users.

Via the input portion 64, the user inputs messages, such as opinions or impressions that the user himself holds regarding the merchandise (Operation Op 1005). If the information provided by the store is announced on an electronic bulletin board, then it is also possible to provide two windows: one for information from the store, and one for user messages (word-of-mouth communication).

The virtual communication space providing portion 30 immediately updates and adds messages received from the user terminal 20 in the user-sent information storage means 34 (Operation Op 1006), and the user-sent information providing means 35 sends the newly updated or added content to the other logged in user terminals 20 (Operation Op 1007).

When appropriate, a logout process is carried out (Operation Op 1008).

The above is an outline of the process flow of the system for providing a virtual communication space of Embodiment 4.

The following explains an application example of this system for providing a virtual communication space on the side of a store supervisor. The virtual communication space provided in Embodiment 4 can be operated with a high application value for the store supervisor.

The supervisor terminal 40 includes a user-sent information monitoring means 41, a user-sent information collecting means 42, a user-sent information database 43, a user-sent information analyzing means 44, and a message sending/receiving means 45. The message sending/receiving means 45 sends and receives message from and to the user's cart-type user terminal 20a when necessary, and the messages are displayed on the liquid crystal display portion 63.

With the user-sent information monitoring means 41, the supervisor terminal 40 can monitor the communication by electronic bulletin board or chat exchanged in the virtual communication space, and collect the original voices of the customers or participants, which can usually not be collected directly, enabling diverse services by immediately analyzing the communication content.

Firstly, it becomes possible to react to the customer's questions, for example regarding availability, of merchandise. When the customer has a question regarding a product, or a question regarding the prospective arrival of a product, the service personnel can answer the question via the supervisor terminal 40, thus the inconvenience of the customer to look for the service personnel in the store can be prevented, as in the prior art. Moreover, the necessity to deploy a large number of service personnel in the store is eliminated, thus contributing to a reduction in personnel costs.

Secondly, the total supervision of the virtual communication space regarding the same product becomes possible. This means, when a company has a plurality of stores, and the same products are on sale in this plurality of stores, then the virtual communication provided at the sales spot of the same product in each store can be regarded as one virtual communication space, and if the exchange of user-sent information is realized spanning a plurality of virtual communications, then the total supervision of virtual communication space spanning all stores with regard to that product becomes possible. In this manner, it is not necessary to have trained personnel for answering questions in each branch, and it is sufficient if there is only one person at the supervisor terminal on the centrally controlled server side.

Thirdly, it becomes possible to make use of electronic direct mail. If the customer complains not directly but in a communication to another user that a certain desired product is not available in the display shelves, then it is preferable not to interrupt directly, but it is possible to let the customer know in a direct and timely in form of general product information when that product will be available again. Additionally, if the customer's interests can be grasped from the content of the communication, it becomes possible to send electronic direct mail regarding related products. For example, announcements regarding health food products currently on sale can be made directly to a customer interested in health food. To send electronic direct mail to a specified customer, that customer's mail address is necessary, and possible ways to obtain the customer's mail address are, for example, letting the customer enter the mail address during the login, letting special customers register their mail addresses in advance and detect a corresponding user terminal ID number during login to obtain the mail address, or letting the user insert/slide a customer card, credit card or the like through a card reader before sending and receiving user-sent information with the user terminal and obtaining a registered mail address from the customer ID number.

Fourthly, different to the previous third aspect that concentrated on immediately sending electronic direct mail, it is also possible to send, at a later date, direct mail by mail to the user's home or electronic direct mail by electronic mail. With the user-sent information collecting means 42, the supervisor terminal 40 can collect message logs, accumulate them in the user-sent information data base 43, analyze the messages by after-processing with the user-sent information analyzing means 44, and classify them into classes that have been previously determined by the system supervisor. Based on the result of the analysis, it is possible to send direct mail corresponding to the customer's needs, which is advantageous to enhance sales.

In this manner, the system for providing a virtual communication space of Embodiment 4 uses a cart-type user terminal, takes sales areas of product sales spots in the store as limited spaces of the real world, automatically constructs the virtual communication space, provides a virtual communication space serving as a place for the free and open exchange of opinions among customers, and allows the store supervisor to provide a diverse and flexible finely tuned service to the customer.

Embodiment 5

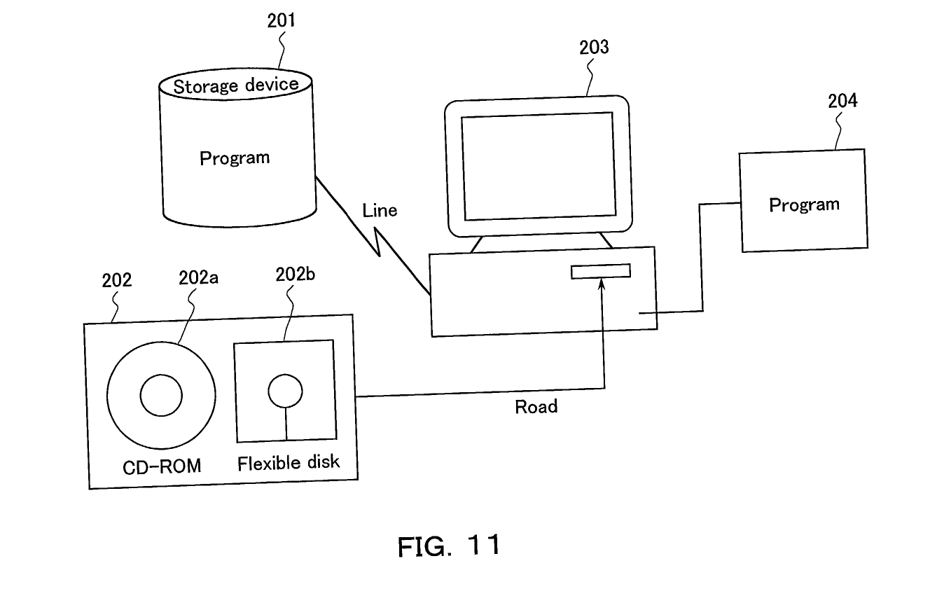

As Embodiment 5 of the present invention an example is shown, in which a computer program for realizing a system for providing a virtual communication space is read into a computer system from a storage medium storing that program, and a system for providing a virtual communication space in accordance with the present invention is organized using a computer. As shown by the examples of storage media shown in FIG. 11, the program can be stored not on only a portable storage medium 202 such as a CD-ROM 202a or a flexible disk 202b, but also on a storage medium 201 in a recording apparatus on a network or a storage medium 204 such as a hard disk of a computer or a RAM. When executing the program, the program is loaded into a computer 203 and executed in its main memory.

Furthermore, the source program does not have to be in compiled form, but it is also possible to send an applet to a client computer 203 over a so-called network 205, and to execute it with an interpreter on the client computer 203.

### INDUSTRIAL APPLICABILITY

With the system for providing a virtual communication space in accordance with the present invention as explained above, a virtual communication space can be provided automatically based on information that a user terminal carried by a user can sense in a limited space of the real world, and a virtual communication space serving as a place for exchanging free and frank opinions among user terminals in the limited space of the real world can be provided, so that the system supervisor can collect and analyze the unfettered opinions exchanged among the users.

Furthermore, with the system for providing a virtual communication space of the present invention, the communication channel identification information is transmitted by a wireless link, a barcode or a reading tag of, for example, alphanumeric characters so that it is simple to construct the virtual communication space automatically. Furthermore, using a GPS system, it is possible to sense the position information of the user terminal carried by the user in the real world, and by obtaining the corresponding communication channel information, a virtual communication space can be provided.

Moreover, the system for providing a virtual communication space of the present invention can use a cart-type user terminal as the user terminal, and taking a sales area, such as a product sales spot in a store, as the limited space in the real world, the virtual communication space can be constructed automatically, and the store supervisor can provide a diverse and flexible finely tuned service to the customer by collecting and analyzing communication.

Moreover, the system for providing a virtual communication space can be constructed as a client-server system using a computer, and by reading with a computer a storage medium storing a program for realizing a virtual communication space of the present invention, it is possible to realize the virtual communication space of the present invention using a computer system.

What is claimed is:

1. A system for providing a virtual communication space, corresponding to sensed information of the real world, between users that have sensed information that is shared in the real world, comprising:
a communication medium providing a communication channel that makes communication in a limited space of the real world possible;
a user terminal comprising a communication channel identification information sensing means for sensing identification information of a communication channel that has been assigned in that limited space of the real world; a channel login means for selecting a communication channel based on the communication channel identification information; a communication means; a means for inputting information; and a communication application for sending and receiving information via the communication channel;
a virtual communication space providing means comprising a communication means; a means for grouping user terminals by assigning a communication channel to the user terminals present in the limited space of the real world; a communication channel identification information transmission means for transmitting identification information of the assigned communication channel to the user terminals; a user-sent information storage means for storing information that has been sent by a user terminal; and a user-sent information providing means for providing information stored in the user-sent information storage means to the user terminal logged into the communication channel.

2. The system for providing a virtual communication space according to claim 1, wherein the communication channel login means comprises a logout means, and the user terminal logs out of the communication channel to which it is logged in by retiring from the virtual communication space or by logging into a communication channel that is assigned to another virtual communication space.

3. The system for providing a virtual communication space according to claim 1, wherein the user-sent information providing means provides user-sent information by posting information on an electronic bulletin board that is maintained for a certain period of time.

4. The system for providing a virtual communication space according to claim 1, wherein the user-sent information providing means provides user-sent information by providing all user-sent information that has been accumulated as history of a predetermined period of time prior to login to user terminals that have newly logged into the communication channel, and thereafter immediately exchanging user-sent information among user terminals that are logged in as chat.

5. The system for providing a virtual communication space according to claim 1,
further comprising a supervisor terminal outside the limited space of the real world;
wherein the communication means comprises an external communication means for external communication with the supervisor terminal; and
wherein the supervisor terminal comprises a channel login means for logging into the communication channel on which communication has become possible with the external communication means, and a communication application for sending and receiving information via the communication channel, wherein information can be sent and received among user terminals in the limited space of the world via the virtual communication space providing means.

6. The system for providing a virtual communication space according to claim 5,
wherein the supervisor terminal further comprises a user-sent information collecting means for collecting the sent records of user-sent information that has been stored by the user-sent information storage means, and a user-sent information database accumulating the user-sent information that has been collected, and
the supervisor terminal further comprises a keyword classification means for classifying by keyword the content of the user-sent information in the user-sent information database, a user-sent information analyzing means for analyzing statistical qualities of the user-sent information that has been classified by keyword, and a direct electronic mail sending means for sending information that is associated with the keyword classification to the user terminal that has sent the user-sent information that has been classified by keyword.

7. The system for providing a virtual communication space according to claim 1,
wherein the communication channel identification information transmission means includes a communication channel identification information notifying means for notifying the assigned transmission channel identification information wirelessly; and
wherein the communication channel identification information sensing means is a receiving means sensing communication channel identification information that has been notified wirelessly from the communication channel identification information notifying means.

8. The system for providing a virtual communication space according to claim 7,
further comprising a supervisor terminal outside the limited space of the real world;
wherein the communication means comprises an external communication means for external communication with the supervisor terminal; and
wherein the supervisor terminal comprises a channel login means for logging into the communication channel on which communication has become possible with the external communication means, and a communication application for sending and receiving information via the communication channel, wherein information can be sent and received among user terminals in the limited space of the world via the virtual communication space providing means.

9. The system for providing a virtual communication space according to claim 8,
wherein the supervisor terminal further comprises a user-sent information collecting means for collecting the sent records of user-sent information that has been stored by the user-sent information storage means, and a user-sent information database accumulating the user-sent information that has been collected, and
the supervisor terminal further comprises a keyword classification means for classifying by keyword the content of the user-sent information in the user-sent information database, a user-sent information analyzing means for analyzing statistical qualities of the user-sent information that has been classified by keyword, and a direct electronic mail sending means for sending information that is associated with the keyword classification to the user terminal that has sent the user-sent information that has been classified by keyword.

10. The system for providing a virtual communication space according to claim 1,
wherein the communication channel identification information transmission means is a communication channel identification information display means for displaying the assigned communication channel identification information; and
wherein the communication channel identification information sensing means is a reading means for reading the communication channel identification information displayed by the communication channel identification information display means.

11. The system for providing a virtual communication space according to claim 10,
further comprising a supervisor terminal outside the limited space of the real world;
wherein the communication means comprises an external communication means for external communication with the supervisor terminal; and
wherein the supervisor terminal comprises a channel login means for logging into the communication channel on which communication has become possible with the external communication means, and a communication application for sending and receiving information via the communication channel, wherein information can be sent and received among user terminals in the limited space of the world via the virtual communication space providing means.

12. The system for providing a virtual communication space according to claim 11,
wherein the supervisor terminal further comprises a user-sent information collecting means for collecting the sent records of user-sent information that has been stored by the user-sent information storage means, and a user-sent information database accumulating the user-sent information that has been collected, and
the supervisor terminal further comprises a keyword classification means for classifying by keyword the content of the user-sent information in the user-sent information database, a user-sent information analyzing means for analyzing statistical qualities of the user-sent information that has been classified by keyword, and a direct electronic mail sending means for sending information that is associated with the keyword classification to the user terminal that has sent the user-sent information that has been classified by keyword.

13. The system for providing a virtual communication space according to claim 1, wherein the user terminal further comprises a position detecting means for detecting position information, and the virtual communication space providing means further comprises a position/communication channel correspondence table showing the correspondence between position information of the real world and communication channel identification information assigned to places indicated by that position information; and
wherein the communication channel identification information sensing means is a means for notifying the detected position information to the virtual communication space providing means, and sensing the communication channel identification information that is returned based on the position/communication channel correspondence table.

14. The system for providing a virtual communication space according to claim 13, wherein the communication channel login means comprises a logout means, and the user terminal logs out of the communication channel to which it is logged in by retiring from the virtual communication space or by logging into a communication channel that is assigned to another virtual communication space.

15. The system for providing a virtual communication space according to claim 13, wherein the user-sent information providing means provides user-sent information by posting information on an electronic bulletin board that is maintained for a certain period of time.

16. The system for providing a virtual communication space according to claim 13, wherein the user-sent information providing means provides user-sent information by providing all user-sent information that has been accumulated as history of a predetermined period of time prior to login to user terminals that have newly logged into the communication channel, and thereafter immediately exchanging user-sent information among user terminals that are logged in as chat.

17. The system for providing a virtual communication space according to claim 13,
further comprising a supervisor terminal outside the limited space of the real world;
wherein the communication means comprises an external communication means for external communication with the supervisor terminal; and
wherein the supervisor terminal comprises a channel login means for logging into the communication channel on which communication has become possible with the external communication means, and a communication application for sending and receiving information via the communication channel, wherein information can be sent and received among user terminals in the limited space of the world via the virtual communication space providing means.

18. The system for providing a virtual communication space according to claim 17,
wherein the supervisor terminal further comprises a user-sent information collecting means for collecting the sent records of user-sent information that has been stored by the user-sent information storage means, and a user-sent information database accumulating the user-sent information that has been collected, and
the supervisor terminal further comprises a keyword classification means for classifying by keyword the content of the user-sent information in the user-sent information database, a user-sent information analyzing means for analyzing statistical qualities of the user-sent information that has been classified by keyword, and a direct electronic mail sending means for sending information that is associated with the keyword classification to the user terminal that has sent the user-sent information that has been classified by keyword.

19. A computer-readable storage medium storing a program for realizing a system for providing a virtual communication space between users that have sensed information that is shared in the real world, the storage medium comprising:
a communication control program for controlling a communication means for providing a communication channel that makes communication in a limited space of the real world possible;
a user terminal processing program comprising a processing operation of sensing identification information of communication channels that have been provided by the communication means; a channel login processing operation of selecting communication channels based on the communication channel identification information; and a communication application for sending and receiving information via the communication channel;
a virtual communication space providing processing program comprising a processing operation of logging into user terminals by a assigning communication channel to user terminals present in the limited space of the real world; a communication channel identification information transmission processing operation of transmitting identification information of an assigned communication channel to a user terminal; a user-sent information storage processing operation of storing information that has been sent by a user terminal via the communication channel; and a user-sent information providing processing operation of providing information stored in the user-sent information storage processing operation to the user terminal accessible via the communication channel.

20. The storage medium according to claim 12,
wherein the storage medium further comprises a processing program for a supervisor terminal that is outside the limited space of the real world;
wherein the communication control program further includes an external communication control program controlling external communication with the processing program for the supervisor terminal;
wherein the processing program for the supervisor terminal comprises a channel login processing operation of logging into the communication channel with which the external communication program has enabled communication, and a communication application for sending and receiving information via the communication channel, and wherein the processing program for the supervisor terminal can exchange information with the processing programs for the user terminals in the limited space of the real world via the virtual communication space providing processing program.
